(19) United States
(12) Patent Application Publication
(10) Pub. No.: US 2017/0218894 A1
(43) Pub. Date: Aug. 3, 2017

(54) FILTER STRUCTURE FOR FUEL, A CARTRIDGE AND A FILTER GROUP

(71) Applicants: UFI FILTERS S.P.A., Porto Mantovano (MN) (IT); UFI INNOVATION CENTER S.R.L., Ala (IT)

(72) Inventor: Giorgio GIRONDI, Mantova (IT)

(21) Appl. No.: 15/127,544

(22) PCT Filed: Mar. 18, 2015
(86) PCT No.: PCT/IB2015/000373

§ 371 Date: Sep. 20, 2016

(30) Foreign Application Priority Data
Mar. 20, 2014 (IT) RE2014A000027

(51) Int. Cl. F02M 37/22; B01D 29/56; B01D 29/23; B01D 17/04

(52) U.S. Cl. CPC F02M 37/221; B01D 17/045; B01D 29/56; B01D 29/232

(57) ABSTRACT

A filter structure for fuel fluids, comprising a first filter wall, a coalescing second filter wall located downstream of and in contact with the first filter wall, and a hydro phobic wall, in which the first filter wall comprises a first porous layer, realised in a material having a receding contact angle Θ rec comprised between 30° and 80°; the coalescing second filter wall comprises a second porous layer made of a material having a greater porosity than the first filter wall; the hydrophobic third wall comprises a layer located at a distance from the second layer.

### TECHNICAL FIELD

The present invention relates to filtration of liquids such as fuel and lubricant, in particular liquids for supplying and lubricating internal combustion engines, in the following also referred-to simply as liquids.

The invention specifically relates to elimination of the parts of water in suspension in the liquids, which when reaching the mechanical organs of the engine create oxidation problems and breakage thereof.

### PRIOR ART

This problem has been object of research for years, and is generally obviated by filter structures through which the fuel is transited, and which are generally made up by a first filter means which has the function of retaining the solid particles, by a second means which has coalescing properties and is able to collect the miniscule particles of water present in suspended in the fuel into droplets of larger dimensions, and by a third means having hydrophobic properties, which retains the particles or droplets of water previously collected, allowing only the fuel to pass through.

The particles or drops retained by the hydrophobic means slide by effect of gravity thereon and fall into the underlying collecting zone.

The means of the structure defined above are shaped as slim layers, which can be in reciprocal contact, or even at least partly spaced, and are generally conformed as concentric toroidal elements constituting the filter cartridge of a usual filter device.

At least the filter layer can have a pleated shape with a star-shaped section.

The separation and elimination of the suspension water obtained with the means of the prior art is however not suitable for responding to the ever-more stringent needs of engine manufacturers, for many reasons.

Firstly the pressure in the engine supply circuit tends to increase, and therefore the droplets of the water-fuel suspension are progressively smaller.

Further, the progressively greater sophistication and precision of the mechanical organs destined to come into contact with the liquids has led to the need to eliminate even minimal quantities of water residues in suspension therein, making the known fuel filters inadequate.

The situation is made worse by the fact that the separation of the water is made more difficult by the presence of additives in the liquids, such as surfactants, which influence the interface tensions, reducing them and therefore making coalescence of the water particles in contact with the coalescing means difficult.

Lastly, in bio-fuels, the water is more rigidly bonded to the fuel; consequently, the separation thereof is more difficult.

In known filter structures, for example described in US document US 2007/0084776 a first layer is present which retains the solid particles, comprising a layer of cellulose able to retain particles having dimensions of from 2μ to 50μ, positioned in contact, upstream of the flow direction of the liquid, with a layer having coalescing properties and constituted by a tangle of fibres having a diameter of up to 50μ, downstream of which is located, at a distance, a third layer for separating the water.

The third layer is constituted by known hydrophobic material having a significantly high porosity so as to minimise a velocity of the liquid crossing it.

The above-mentioned document teaches that by arranging the layer of hydrophobic material able to realise the barrier for the water downstream and at a distance the coalescing means and the cellulose means able to retain the solid particles, for separating the water from the already-filtered liquid, an improvement is obtained in the time and effectiveness of the water-separating means.

A device using the above structure is described in document WO 2014/009060, which relates to a water separator device in a filter element of the fuel.

However, the devices made according to the teachings of the prior art exhibit the drawback of not completely separating the water from the fuel due to the small dimensions of the water droplets themselves and the high flow-rate; the combination of these two factors (diameter of the water droplets, fuel flow-rate) prevents the coalescing filter wall from uniting the droplets of small dimensions which pass too quickly through the coalescing filter, and which can then pass between the links of the hydrophobic mesh located downstream of the filter/coalescing filter wall.

The aim of the present invention is to disclose a structure able to obviate the above-delineated drawbacks with a solution that is effective, simple and relatively inexpensive.

This aim is attained by a filter structure having the characteristics listed in the independent claim, and by a fuel filter unit comprising the structure.

### DESCRIPTION OF THE INVENTION

An embodiment of the invention provides a filter structure and a water separator for fuel fluids of a type comprising a first filter wall, a coalescing second filter wall located downstream and in contact with the first filter wall, and a third hydrophobic wall, in which the first filter wall comprises a first porous layer, realised in a material having a receding contact angle Θ_{rec} comprised between 30° and 80°, the coalescing second filter wall comprises a second porous layer made of a material having a greater porosity than the first filter wall, the hydrophobic third wall comprises a layer located at a distance from the second layer.

In particular, the receding contact angle Θ_{rec} is an indicative parameter of a Θ_{rec} is wettability of a material. More in general, the degree of wettability of non-homogeneous and theoretically not ideal material, such as the filter means (wall) in relation to the water, is taken to be the contact angle of a drop of water with a surface of the material, and precisely the angle Θ formed by the tangent to the drop with respect to the surface on the contact line between the drop and the surface, measured from the drop.

When the drop of water is static on the surface of the material on which the wettability is to be measured, the contact angle Θ is the same in all directions.

When the drop moves, following for example a thrust in the flow it is dispersed in, or because the surface is inclined, two contact angles exist, precisely:
the advancing contact angle Θₐᵥ formed by the tangent to the drop in the contact point downstream in the advancing direction;
the receding contact angle Θ_{rec} formed by the tangent of the drop in the contact point upstream in the advancing direction.

Obviously the value of the contact angle of a static drop is comprised between the receding contact angle Θ_{rec} and the advancing contact angle Θₐᵥ, i.e. the following relation is respected:

Θ_{rec}<Θₛₜ<Θₐᵥ.

In the present embodiment of the invention, the receding contact angle, which is, as mentioned, a parameter indicating the degree of wettability of the material constituting the first layer, is comprised within the following range: 30°<Θ_{rec}<80° (sexagesimal degrees).

Significantly the extreme values of the range indicated are very different from corresponding typical extreme values for the material of the first filter wall used as a rule in the prior art, in which the value of the receding angle Θ_{rec} is comprised in the following range: 0°<Θ_{rec}<20°.

Thanks to the specific characteristics of wettability of the material, the water particles are not retained in the first filter wall, but are instead braked when crossing the first wall (lowering the crossing velocity thereof) which due to the fine porosity thereof retains the solid particles present in the fuel.

In an aspect of the first embodiment of the invention, the first filter wall, located upstream in the flow direction of the liquid, which has the true and proper filtering function, has a porosity comprised between 1 μm and 5 μm.

In a further aspect of the first embodiment of the invention, the first filter wall has a thickness comprised between 0.1 and 2.0 mm.

In a further aspect of the first embodiment of the invention, the first filter wall is made using a material having a weight comprised between 50 and 350 gr/m³.

In a further aspect of the first embodiment of the invention, the first filter wall is made of polyester.

In a preferred embodiment, the material used for the first filter wall is polybutylene terephthalate (PBT).

In an aspect of the invention, the second coalescing filter wall comprises a second porous layer realized in a material having a greater porosity than that of the first filter wall.

In a preferred aspect of the invention, the second filter wall, located downstream of the first filter wall, exhibits a porosity comprised between 3 μm and 10 μm.

In a further aspect of the invention, the coalescing second filter wall has a greater thickness than the first filter wall.

In other embodiments the second coalescing filter wall might exhibit a thickness equal to or substantially equal to that of the first filter wall.

In a preferred aspect of the invention the coalescing second filter wall has a thickness comprised between 1 mm and 5 mm.

In other embodiments the second coalescing filter wall might exhibit a thickness comprised between 0.5 mm and 1 mm, for example equal to or substantially 0.7 mm.

In a further aspect of the invention, the coalescing second filter wall is made with a material having a weight of between 200 and 600 gr/m³.

In the first embodiment of the invention the coalescing second filter wall is made of a poorly-hydrophilic material therefore having a low degree of wettability. In general the coalescing filter wall might for example be made of the same material as the first filter wall.

In a particular aspect of the invention the coalescing second filter wall can be made with a coalescing material exhibiting a structure and a composition of known type, i.e. having the coalescing effect relative to the droplets of water present in the liquid to be filtered, such as for example: viscose, polyester, fibreglass, monocomponent fibres, bicomponent fibres and/or biconstituent fibres.

With the described characteristics of the first and second filter walls, the filter structure according to the first embodiment of the invention is able to collect drops (particles) of water having a significantly smaller diameter than what has been possible up to now in the prior art. This is due to the fact that, as mentioned, the water droplets are slowed down, without being retained, when crossing the first filter wall because of the characteristic thereof of having a low degree of wettability and due to the low porosity thereof, and thus take longer to cross the second coalescing filter wall, and the collecting thereof is in this way facilitated, even those particles (droplets) having very small dimensions. In the coalescing second wall, therefore, water droplets are formed which have larger dimensions than those which form in the filter structures of the prior art and which therefore can be stopped more easily by the hydrophobic third filter wall located downstream, in the flow direction, of the coalescing second filter wall.

The third filter, though having, as is usual, a higher porosity than the two upstream filter walls, can retain a percentage of water that is comparatively much higher than what was possible up to now.

In a particular aspect of the invention, the hydrophobic third filter wall has a porosity comprised between 15 μm and 100 μm.

In a further aspect of the invention the hydrophobic third wall has a thickness comprised between 0.035 mm and 1 mm.

In a further aspect of the invention the hydrophobic third wall has a weight comprised between 10 and 100 gr/m³.

A second embodiment of the invention discloses a filter cartridge for fuel comprising an upper plate and a lower plate between which a filter structure for fuel fluids comprising a first filter wall is located; a coalescing second filter wall located downstream and in contact with the first filter wall, and a hydrophobic wall, characterised in that:
the first filter wall comprises a first porous layer, realised in a material having a receding contact angle Θ_{rec} comprised between 30° and 80°,
the hydrophobic wall comprises a layer located at a distance from the second layer.

In a third embodiment of the invention, a filter group is disclosed which comprises an external casing provided with an inlet conduit for the fuel to be filtered and an outlet conduit for the filtered fuel, internally of which a fuel filter cartridge is housed and comprising an upper plate and a lower plane between which a filter structure is located for fuel fluids, comprising a first filter wall, a coalescing second filter wall located downstream and in contact with the first filter wall, and a hydrophobic wall, in which:
the first filter wall comprises a first porous layer, realised in a material having a receding contact angle Θ_{rec} comprised between 30° and 80°,
the hydrophobic wall comprises a layer located at a distance from the second layer.

In an aspect of this embodiment, the second filter wall can comprise a porous layer realized in a material having a greater porosity than that of the first filter wall.

In a further embodiment of the invention, a filter group for fuel fluids is disclosed which comprises an external casing able to delimit a first chamber, supplied via an inlet opening for the fluid to be filtered, in fluid connection with a second chamber, communicating with an outlet opening for the filtered fluid, and comprising a filter structure composed of a first filter wall, a second coalescing filter wall located downstream of and in contact with the first filter wall, and a hydrophobic wall, wherein:
the first filter wall comprises a first porous layer, realised in a material having a receding contact angle Θ_{rec} comprised between 30° and 80°,
the hydrophobic wall comprises a porous layer located at a distance from the coalescing filter wall.

In an aspect of this embodiment, the coalescing filter wall can comprise a porous layer realized in a material having a greater porosity than that of the first filter wall.

In a further aspect of this embodiment, the first filter wall and the second coalescing filter wall can be located in the first chamber in order to be crossed by the fuel in the first chamber.

In a further aspect of this embodiment, the hydrophobic wall can be located in the second chamber in order to be crossed by the fuel in the second chamber.

### BRIEF DESCRIPTION OF THE FIGURES

The advantages and constructional and functional characteristics of the invention will emerge from the detailed description that follows, which with the aid of the accompanying tables of drawings illustrates some preferred embodiments of the invention by way of non-limiting example.

FIG. 1 is a section view of the structure of the invention;

FIG. 2 is a section view of a filter group and a filter cartridge according to the invention.

FIG. 3 is a plan section of a filter group according to an alternative embodiment of the invention;

FIG. 4 illustrates section IV-IV of FIG. 1.

### BEST WAY OF CARRYING OUT THE INVENTION

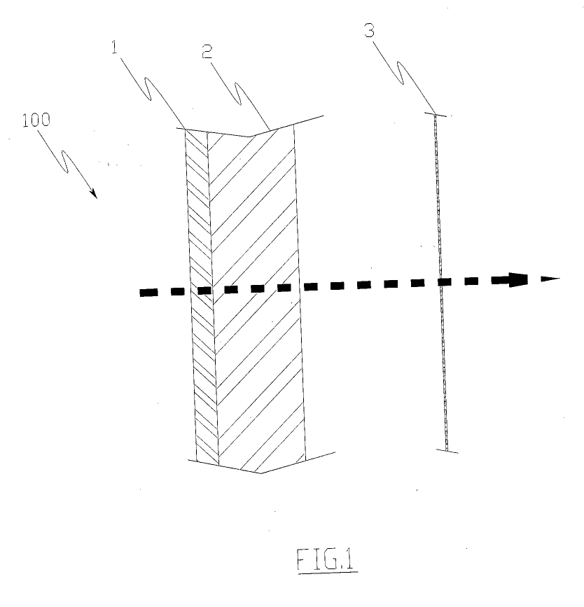

FIG. 1 shows an embodiment of the filter structure 100 and the water separator according to the invention.

The structure 100 comprises a first filter wall 1 for separating impurities from the fuel. According to the invention the first filter wall comprises a porous layer of a material with a low degree of wettability, i.e. with a receding contact angle Θ_{rec} comprised between 30° and 80°.

In the illustrated embodiment the first filter wall, is made from polybutylene terephthalate, and has a porosity of 5 μm, a thickness of 0.5 mm, and a weight of 200 g/m².

In other embodiments of the invention the first filter wall can also be made of polyester or any other material suitable for the purpose and exhibiting a receding contact angle Θ_{rec} comprised between 30° and 80°.

A coalescing second filter wall 2 is positioned downstream, in the flow direction of the fuel to be treated and in contact with the first filter wall 1.

The coalescing second filter wall 2 can be made of a material exhibiting a coalescing structure and a known composition, i.e. one that is able to obtain the coalescing effect in relation to water particles present in the fluid fuel to be filtered.

For example, the second filter wall 2 can be made of viscose, polyester, glass fibre, single-component fibre, bi-component fibre and/or bi-constituents.

In the illustrated embodiment the second filter wall 2 is made of polyester and has a porosity of 5-20 μm, a thickness of 2 mm, and a weight of 450 g/m².

In general, in accordance with the invention the coalescing second filter wall 2 must exhibit a greater porosity than the first filter wall 1. Further, in a preferred embodiment, the coalescing second filter wall 2 has a greater thickness than the first filter wall 1.

It is however possible for the filter walls 1 and 2 to be of a same thickness, for example comprised between 0.5 mm and 1 mm, preferably substantially 0.7 mm.

A hydrophobic wall 3 is located downstream of the second filter wall 2, which hydrophobic wall 3 is able to provide a barrier against the water droplets that have collected while crossing the coalescing second filter wall 2.

The hydrophobic wall 3 is located at a certain distance from the coalescing second filter wall 2. Preferably, this distance varies from 0.1 mm to 20 mm depending on applications.

According to a preferred embodiment the hydrophobic wall 3 comprises a network of fibres, known per se, having a hydrophobic surface.

The hydrophobic wall 3 is preferably made of polyester, preferably polyethylene terephthalate (PET) coated with a hydrophobic material, for example a silicone or fluorinated material.

In the present embodiment the hydrophobic wall 3 has a porosity of 20 μm, a thickness of 38 μm and a weight of 26 g/m³.

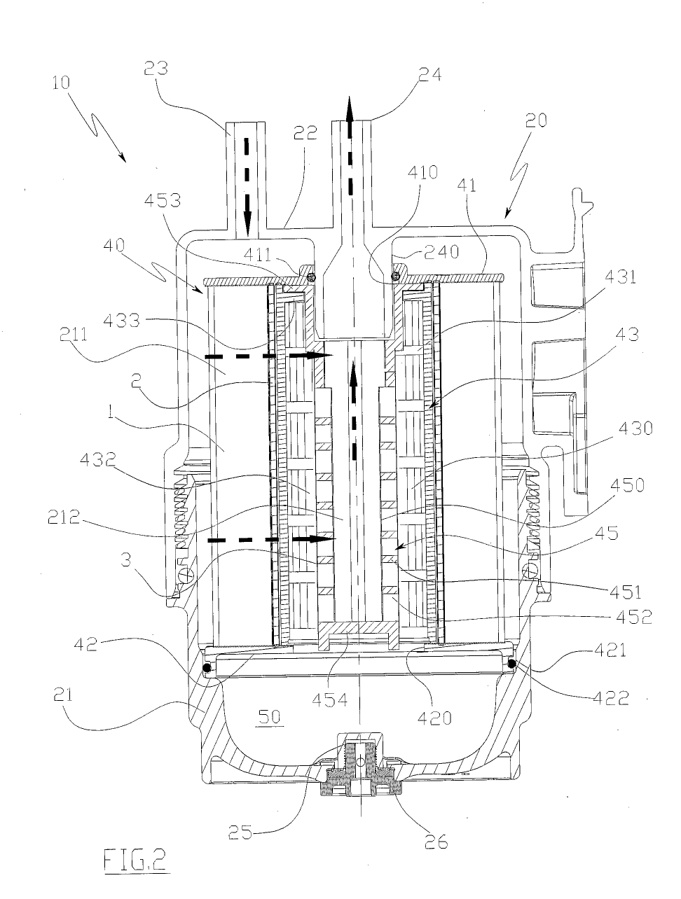

The structure 100 illustrated in FIG. 1 is applied in a filter cartridge 40 intended, for example, to be used in a filter assembly 10 (FIG. 2), for the filtration of fluids, particularly fuel for an internal combustion engine.

The filter assembly 10 comprises an external casing, denoted in its entirety by 20, provided with an inlet conduit 23 for the fuel to be filtered and an outlet conduit 24 for the filtered fuel.

In the illustrated embodiment the casing 20 comprises a cup-shaped body 21, and a cover 22 able to close the cup-shaped body 21, on which the inlet conduit 23 for the fuel filter and the outlet conduit 24, which is axial, for the filtered fuel are located.

The cup-shaped body 21 comprises, positioned at a bottom thereof, a discharge conduit 25 for the water that accumulates on the bottom of the cup-shaped body 21, provided with a closure cap 26.

The filter cartridge 40 is accommodated internally of the casing 20, which filter cartridge 40 divides the internal volume of the casing 20 into two distinct chambers 211, 212, of which a first chamber 211 for the fuel to be filtered (in the example external), in communication with the inlet conduit 23, and a second chamber 212 of the filtered fuel (in the example internal), in communication with the outlet conduit 24.

The filter cartridge 40 comprises an upper support plate 41 and a lower support plate 42 between which the previously-described filter structure 100 is located.

The upper support plate 41 is substantially disc-shaped and affords a central hole 410 centred on the longitudinal axis A of the filter cartridge 40.

The lower support plate 42 is also substantially disc-shaped and has a central hole 420 centred on the longitudinal axis A of the filter wall 43.

The central hole 410 of the upper support plate 41 inserts on a terminal internal end portion of the outlet conduit 24, with the interposing of a usual seal ring 411 fixed in a suitable seating at the central hole 410.

The lower support plate 42, instead, enters and rests on the bottom of a cylindrical annular seating 421 afforded in the vicinity of the bottom of the cup-shaped body 21 (at a distance therefrom) by interposing of a further seal ring 422.

In the present embodiment, the first filter wall 1 and the coalescing second wall 2 are realized as loop-closed pleated walls, i.e. exhibiting, in horizontal section, a known star-shape.

The first filter wall 1 and the coalescing second filter wall 2 are inserted externally of a cylindrical core 43 that connects the first and the second plate.

The core 43 exhibits a cage-like structure of substantially tubular shape and a diameter substantially equal to (or slightly smaller than) the internal diameter of the coalescing second filter wall 2.

In particular, the cage structure of the core 43 is constituted by a plurality of vertical uprights 430 (e.g. equidistant) which join a plurality of horizontal rings 431 (for example, equidistant) defining the openings 432 for the passage of the fluid.

The opposite ends of the longitudinal core 43 are both open and respectively fastened, for example by gluing or welding, to the facing internal faces of the upper support plate 41 and the lower support plate 42.

A second core 45 is housed internally of the core 43, coaxial to the first core 43 and having a cage-like structure exhibiting a substantially tubular shape and a diameter that is smaller than the diameter of the first core 43.

In particular, the cage structure of the core 45 is constituted by a plurality of vertical uprights 450 (e.g. equidistant) which join a plurality of horizontal rings 451 (for example, equidistant) defining the openings 452 for the passage of the fluid.

The hydrophobic wall 3 of the filter structure 100 is inserted on the external surface of the second core 45.

In other embodiments of the invention the hydrophobic wall 3 can be associated to the external or internal surface of the second core 45 by means of a method of any known type, for example by welding or gluing.

The upper end of the second core 45 is inserted into an internal extension 240 of the discharge conduit 24 and exhibits at an edge thereof a flange 453, a lower surface of which rests against an annular shelf 433 that branches internally from the first core 43. With this configuration, the flange 453 of the core is clamped between the annular shelf 433 and the upper plate 41.

The lower end of the second core 45 is, instead, closed by a disc-shaped body 454 located at the central hole of the lower plate 42.

In the light of the foregoing, the operation of the filter assembly 10 is evident.

The flow of fuel to be treated moves from the periphery towards the centre of the filter assembly 10.

The fuel passes through the first filter wall 1, which, thanks to its low porosity, separates the impurities from the fluid. When passing through the first filter wall 1, the fuel and the water particles in it reduce speed thanks both to the low degree of wettability of the material of which the wall is made and to the low porosity of the first filter wall 1.

Subsequently, the fluid (fuel and water particles) passes through the coalescing second filter wall 2, which by virtue of the coalescing effect collects the water particles to form larger-size drops. The drops of collected water are blocked by the hydrophobic wall 3, which instead allow the filtered fuel to pass through, which filtered fuel is then directed towards the outlet conduit 24.

The drops of water blocked by the hydrophobic fall by effect of gravity into a lower collecting chamber superiorly delimited by the lower plate 42, and from there are discharged through the discharge hole 25.

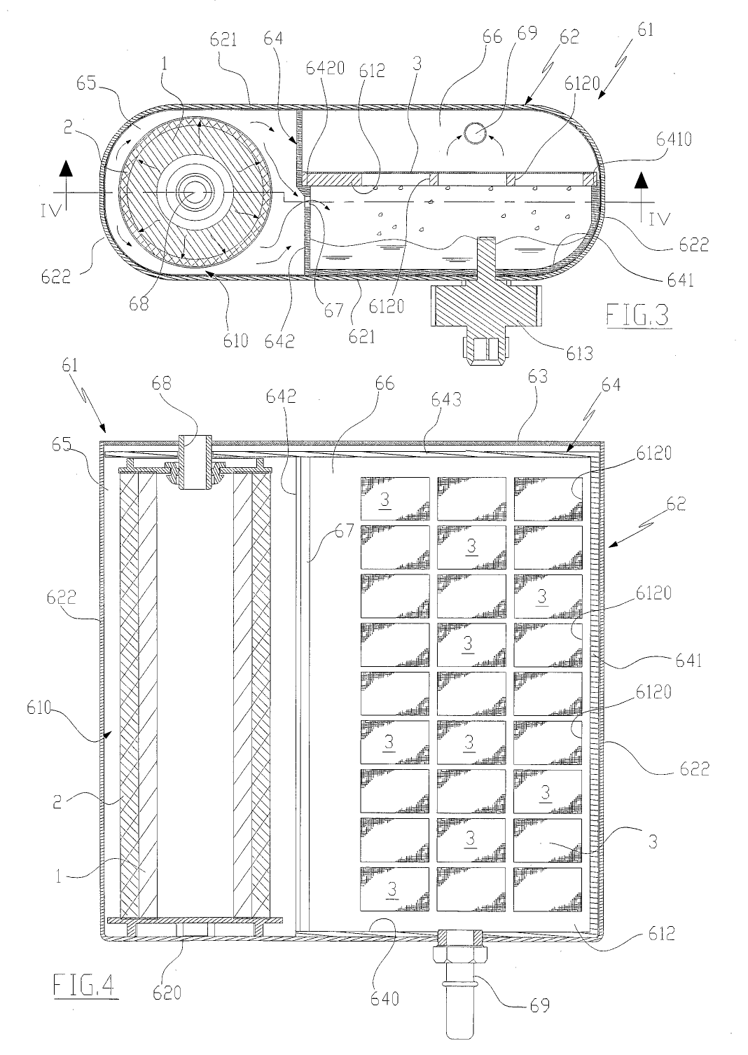

The structure 100 illustrated in FIG. 1 is also applied in a filter assembly 61 of the type illustrated in FIG. 3, also for the filtration of fluids, particularly fuel for an internal combustion engine.

The filter group 61 comprises an external container 62 conformed for example as a tray a mouth of which is closed by a cover 63.

The bottom 620 of the container 62 has a narrow and elongate shape and exhibits two sides 621, parallel to one another, ends of which are joined by two curved portions 622.

A profiled element 64 is housed internally of the container, comprising a horizontal plate 640, from which a first vertical part 641 rises, which has a complementary shape to the internal surface of the container 62, against which it rests, and a second part 642, also a wall, which branches from an end of the first portion 641 and is arranged perpendicularly thereto so as to define a vertical wall. The wall divides the internal volume of the container 62 into a first and a second chamber 65 and 66, fluidly connected; these chambers can communicate, for example, thanks to a vertical slot 67 fashioned in the part 642 defining the wall. As can be observed from the figures, the two chambers 65 and 66 can be flanked to one another and develop in the direction of the height of the container.

An inlet conduit 68 of the fuel heads the chamber 65, which can open above the cover 63; while an outlet conduit 69 of the fuel heads the chamber 66, which can open below the bottom 620 of the container 62.

A filter cartridge 610 is housed internally of the chamber 65, for filtering the fuel which is sent internally of the filter group through the inlet conduit 68.

In the illustrated embodiment, the filter cartridge 610 is toroidal and can be crossed radially from inside towards outside, but this does not exclude the possibility in other embodiments of the invention for it to be crossed from outside to inside, or for it also to have a different shape, for example flat.

The filter cartridge 610 comprises the first filter wall 1 and the second coalescing filter wall 2 of the filter structure 100, which are arranged in such a way as to be crossed in series by the fuel: first the filter wall 1 and then the coalescing filter wall 2.

In the present embodiment, the first filter wall 1 and the coalescing second wall 2 are generally tubular in shape and are coaxially inserted one inside the other.

For example, they can be realized as loop-closed pleated walls, i.e. exhibiting, in horizontal section, a known star-shape.

The profiled body 64 further comprises a horizontal upper plate 643 which is located below the cover 63 and has the function of preventing axial translations of the filter wall 610.

The fuel that crosses the filter wall 610 pours into the second chamber 66, in which the hydrophobic wall 3 of the filter structure 100 is housed, which has the function of preventing passage of the water droplets collected by the coalescing filter 2, so as to separate the water from the diesel fuel.

In greater detail, during normal functioning, the fuel enters the chamber 65 from the inlet conduit 68, passes through the first filter wall 1, which, thanks to its low porosity, separates the impurities from the fluid. When passing through the first filter wall 1, the fuel and the water particles in it reduce speed thanks both to the low degree of wettability of the material of which the wall is made and to the low porosity of the first filter wall 1. Subsequently, the fluid (fuel and water particles) passes through the coalescing second filter wall 2, which by virtue of the coalescing effect collects the water particles to form larger-size drops. The filtered fuel collects in the second chamber 66, passing for example through the opening 67 in which the drops of collected water are blocked by the hydrophobic wall 3, which instead allows the filtered fuel to pass through, which filtered fuel is then directed towards the outlet conduit 69.

In fact the water has a specific weight that is greater than that of the diesel fuel, so that the droplets of water tend to collect on the bottom of the chamber 66.

In the illustrated example the hydrophobic wall 3 is applied to a panel 612, which is supported by the profiled element 64 and is provided with a plurality of openings 6120 which are closed by the hydrophobic wall 3.

In particular, a side of the hydrophobic wall 3 rests in a step 6410 fashioned at the end of the part 641 of the element 64, while the opposite side rests on a step 6420 of the wall 642.

The water that collects on the bottom of the second chamber 66 is expelled through a usual drainage means 613, for example a usual tap located on the bottom of the chamber. The diesel fuel separated from the water, differently, exits from the second chamber through the outlet conduit 69.

From what is described above it can be deduced that the filter group advantageously makes available a filter structure 100 which is distributed in two distinct chambers 65 and 66, in which the first chamber 65 contains the filter wall 1 and the coalescing filter wall 2, while the second chamber 66 only contains the hydrophobic wall 3.

In other words, a filter group is disclosed which according to the invention comprises an external casing with a first and a second chamber 65 and 66, in fluid communication, in which the first filter wall 1 and the second coalescing filter wall 2 are placed in contact with one another and are crossed in series by the flow of fuel in the first chamber 65, while the hydrophobic wall is located at a distance from the second coalescing filter wall and is crossed by the flow of fuel in the second chamber 66.

In this way, the collection chamber of the water exhibits large dimensions and is able to collect a quantity of water that is considerably greater than that collected in other filter groups. Therefore maintenance of the group, i.e. the need to intervene to remove the water collected in the chamber, can be less frequent.

The invention as it is conceived is susceptible to numerous modifications and variants, all falling within the scope of the inventive concept.

Further, all the details can be replaced with other technically-equivalent elements.

In practice the materials used, as well as the contingent shapes and dimensions, can be any according to requirements, without forsaking the scope of protection of the following claims.

1. A filter structure (100) for fuel fluids, comprising a first filter wall (1), a coalescing second filter wall (2) located downstream and in contact with the first filter wall (1), and a hydrophobic wall (3), wherein:
the first filter wall (1) comprises a first porous layer, realized in a material having a receding contact angle Θrec comprised between 30° and 80°,
the hydrophobic wall (3) comprises a layer located at a distance from the second coalescing filter wall (2).

2. The filter structure of claim 1, wherein the material of the first filter layer (1) is polyester.

3. The filter structure of claim 1, wherein the material of the first filter layer (1) is polybutylene terephthalate.

4. The filter structure of claim 1, wherein the coalescing second filter wall (2) has a greater thickness than the first filter wall (1).

5. The filter structure of claim 1, wherein the coalescing second filter wall (2) comprises a second porous layer realized in a material having a greater porosity than the first filter wall.

6. The filter structure of claim 1, wherein the material of the coalescing second filter layer (2) is selected from among following: viscose, polyester, fibreglass.

7. A filter cartridge (40) for fuel, comprising an upper plate (41) and a lower plate (42) between which a filter structure (100) for fuel fluids comprising a first filter wall (1) is located; a coalescing second filter wall (2) located downstream and in contact with the first filter wall, and a hydrophobic wall (3), wherein:
the first filter wall (1) comprises a first porous layer, realized in a material having a receding contact angle Θrec comprised between 30° and 80°,
the hydrophobic wall (3) comprises a layer located at a distance from the second layer.

8. The filter cartridge of claim 7, wherein the material of the first filter layer (1) is polyester.

9. A filter group (10) comprising an external casing (20), provided with an inlet conduit (23) for the fuel to be filtered and an outlet conduit (24) for the filtered fuel, internally of which a filter cartridge (40) is housed, according to claim 7.

10. The filter cartridge of claim 7, wherein the material of the first filter layer (1) is polybutylene terephthalate.

11. The filter cartridge of claim 7, wherein the coalescing second filter wall (2) has a greater thickness than the first filter wall (1).

12. The filter cartridge of claim 7, wherein the coalescing second filter wall (2) comprises a second porous layer realized in a material having a greater porosity than the first filter wall.

13. The filter cartridge of claim 7, wherein the material of the coalescing second filter layer (2) is selected from among following: viscose, polyester, fibreglass.
